(19) United States
(12) Patent Application Publication
(10) Pub. No.: US 2024/0260780 A1
(43) Pub. Date: Aug. 8, 2024

(54) PORTABLE HOT LIQUID CONTAINER AND/OR HEATER

(71) Applicant: Dvir AMIR, Yad Binyamin (IL)

(72) Inventor: Dvir AMIR, Yad Binyamin (IL)

(21) Appl. No.: 18/560,938

(22) PCT Filed: May 9, 2022
(86) PCT No.: PCT/IL2022/050480

§ 371 Date: Nov. 15, 2023

(30) Foreign Application Priority Data
May 18, 2021 (US) 63/189733

(51) Int. Cl. A47J 27/21

(52) U.S. Cl. CPC A47J 27/21016; A47J 27/21075

(57) ABSTRACT

A liquid container and heating element may be capable of boiling a liquid. A heating element is built into the container and/or the heating element and container may be modular. Optionally, the liquid heating system may be functionable without being plugged in to an electricity source. For example, it may be portable and/or battery powered. Optionally, there may be insulation between the power supply (e.g., battery) and the heating element. Optionally, the electrical elements may be configured for a high current and/or low voltage. Optionally, the liquid heating system may be insulated to keep the contents in a desired temperature. For example, a steam cover may cover a steam hole for when the heating unit is not active and/or may be automatically removed when the heating unit is active.

### RELATED APPLICATION/S

This application claims the benefit of priority under 35 USC § 119(e) of U.S. Provisional Patent Application No. 63/189,733 filed 18 May 2021, the contents of which are incorporated herein by reference in their entirety.

### FIELD AND BACKGROUND OF THE INVENTION

The present invention, in some embodiments thereof, relates to a liquid container and, more particularly, but not exclusively, a liquid container with a self-contained heating function.

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

### SUMMARY OF THE INVENTION

According to an aspect of some embodiments of the invention, there is provided a liquid heating system including: a liquid storage unit including a container with a steam hole configured for allowing steam generated by heating the liquid in the liquid storage unit to escape therethrough; a steam hole cover, which covers the steam hole; a heating element, located within the liquid storage unit to heat the liquid in the liquid storage unit; an activation switch, connected to the steam hole cover and to the heating element such when the activation switched is in an on position, the heating element is activated and the steam hole is opened and when the activation switched is in an off position, the heating element is deactivated and the steam hole is closed; and a power source, for supplying power connected to the activation switch and to the heating element.

According to some embodiments of the invention, the liquid heating system further includes a cover to the liquid storage unit.

According to some embodiments of the invention, the liquid heating system further includes a casing surrounding the liquid heating system.

According to some embodiments of the invention, the liquid heating system further includes: electrical wires connecting the power source to the activation switch and to the heating element are made from or are surrounded by a reduced heat conducting material.

According to some embodiments of the invention, the power source contains stored power.

According to some embodiments of the invention, the power source is selected from a rechargeable battery and an external battery.

According to some embodiments of the invention, the power source is selected from a photovoltaic system, a wall socket, an AC power source, or a DC power source.

According to some embodiments of the invention, at least one of the liquid storage unit, the power source, and connecting electrical wires are insulated by a heat insulator.

According to some embodiments of the invention, the heat insulator includes a reduced heat conducting material.

According to some embodiments of the invention, the reduced heat conducting material is selected from at least one of air, polystyrene foam, polyurethane foam, silicone, plastic, fiberglass, mineral wool, cellulose, cork, ceramic, a radiant heat protector, a coating.

According to some embodiments of the invention, closing the steam hole with the steam hole cover assists in insulating the liquid storage unit.

According to some embodiments of the invention, the liquid heating system further includes a control panel.

According to some embodiments of the invention, the control panel is connected to the activation switch and to the power supply.

According to some embodiments of the invention, the control panel includes one or more indicators.

According to some embodiments of the invention, an indicator shows that the heating element is functioning.

According to some embodiments of the invention, an indicator shows that the liquid is hot.

According to some embodiments of the invention, the liquid heating system further includes a safety feature.

According to some embodiments of the invention, the liquid heating system is portable.

According to some embodiments of the invention, the liquid storage unit cover is opened to add at least one of a liquid and an additive wherein the additive is selected from a flavorant, a vitamin supplement, an energy supplement, a water purification substance.

According to an aspect of some embodiments of the invention, there is provided a method for storing and heating liquid including: storing a liquid in a liquid storage unit until heating is required; activating a switch; opening a steam hole in the liquid storage unit in response to the activating; drawing power from a power source to a heating element contained within the liquid storage unit in response to the activating to produce heat, heating the liquid in the liquid storage unit with the heat to boil the liquid; passing steam from the boiled liquid through the steam hole; releasing the switch in response to the passing; and deactivating of the heating element in response to the releasing.

According to some embodiments of the invention, activating the switch results in pushing a switch extension thereby moving a steam hole cover away from the steam hole and opening the steam hole.

According to some embodiments of the invention, deactivating the switch results in releasing a switch extension allowing a steam hole cover to close the steam hole.

According to some embodiments of the invention, the method further includes preventing activating the heating element when the liquid storage unit is open.

According to some embodiments of the invention, the method further includes preventing activating the heating element when the liquid storage unit is not right side up.

According to some embodiments of the invention, the method further includes insulating the liquid storage unit by closing a cover of the steam hole in response to the deactivating of the heating element.

According to some embodiments of the invention, the method further includes storing the heated liquid for later use.

According to some embodiments of the invention, the method further includes reheating stored liquid.

According to some embodiments of the invention, the method further includes controlling the heating via a hard wired or wireless connection.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) and/or a mesh network (meshnet, emesh) and/or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

Data and/or program code may be accessed and/or shared over a network, for example the Internet. For example, data may be shared and/or accessed using a social network. A processor may include remote processing capabilities for example available over a network (e.g. the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an expanded schematic illustration of a liquid heating system in accordance with the current invention;

FIG. 2 is a schematic illustration of a liquid heating system in accordance with the current invention;

FIGS. 3A-3C illustrate an embodiment of the current invention in an inactive state;

FIGS. 4A-4C illustrate an embodiment of the current invention in an active state;

FIG. 5 is a schematic illustration in accordance with an embodiment of the current invention;

FIGS. 6A, 6B, 7A and 7B are schematic illustrations of a heating element in accordance with an embodiment of the current invention;

FIG. 8 is a schematic illustration of a liquid heating system in accordance with an embodiment of the current invention;

FIG. 9 is an exploded view of liquid heating system for storing and heating liquid in accordance with an embodiment of the current invention;

FIG. 10 is a flow chart illustration of a method of heating and/or boiling a liquid in accordance with an embodiment of the current invention; and

FIG. 11 is a block diagram of a liquid heating system in accordance with an embodiment of the current invention.

### DESCRIPTION OF SPECIFIC EMBODIMENTS OF THE INVENTION

The present invention, in some embodiments thereof, relates to a liquid container and, more particularly, but not exclusively, a liquid container with a self-contained heating function.

### Overview

An aspect of some embodiments of the current invention relates to a liquid container and heating element which may be capable of boiling a liquid. In some embodiments, the heating element is built into the container. Alternatively, or additionally, the heating element and container may be modular. Optionally, the liquid heating system may be functionable without being plugged in to an electricity source. Optionally, the liquid heating system may be portable and/or may be battery powered. Optionally, there may be insulation between the power supply (e.g., battery) and the heating element. Optionally, the electrical elements may be configured for a high current and/or low voltage. Optionally, users may wish to bring the liquid heating system with them and/or at a desired time bring the contents of the liquid heating system to a boil and/or to a desired heat. For example, a user may wish to transport powdered coffee and/or tea in the liquid heating system and/or at a desired time to bring the contents to a boil without requiring an external electric source. For example, a user may wish to heat water for bathing, cooking and/or drinking in an area with little to no infrastructure. Optionally, this may aid a user that the content of the liquid heating system can remain cold until a desired time and/or may be heated and/or boiled at a desired time. Optionally, the liquid heating system may be insulated to keep the contents in a desired temperature. For example, the heating system may be modular and/or may be transferable from one container to another. Optionally, the liquid heating system may have one or more safety features.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

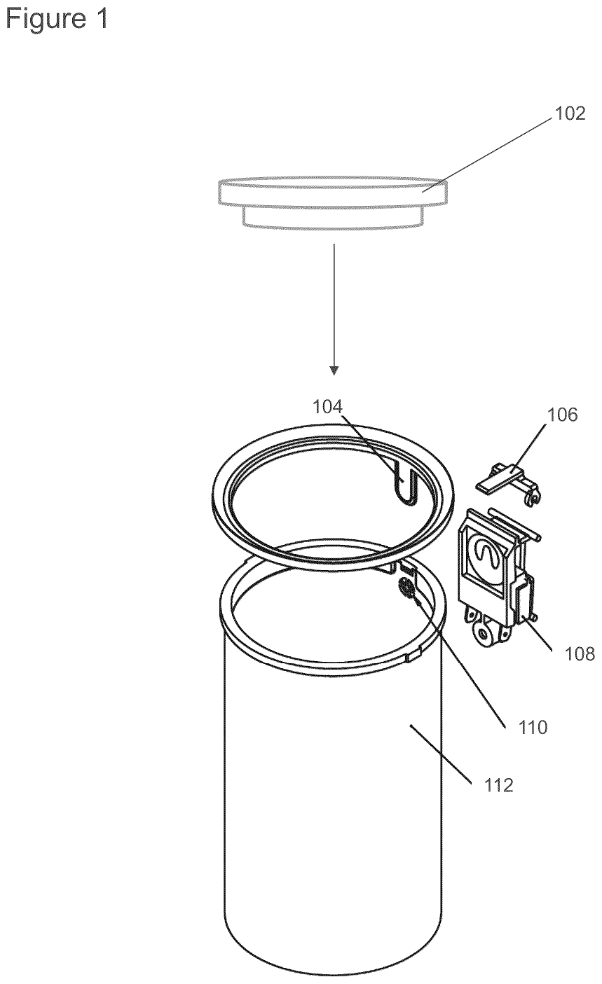

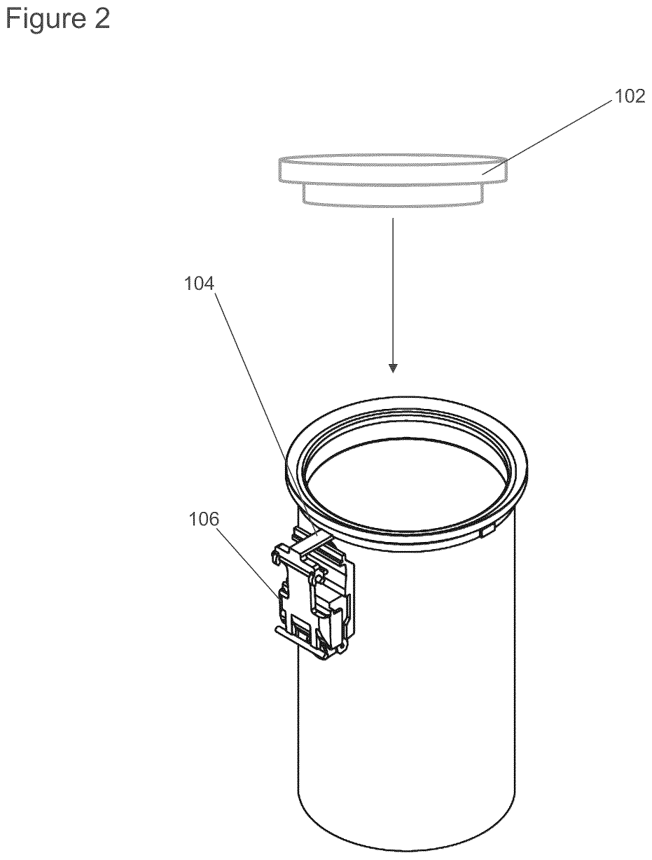

FIG. 1 is an expanded schematic illustration of a liquid heating system in accordance with the current invention. FIG. 2 is a schematic illustration of a liquid heating system in accordance with the current invention.

In an embodiment of the current invention, liquid heating system may include a liquid container and/or liquid storage unit 112 and/or a container cover 102. Optionally, the liquid storage unit 112 may be opened by removing the container cover, for example 102 to clean the liquid storage unit. Additionally, and/or alternatively, the storage unit 112 may be opened to pour in one or more liquids and/or to add one or more additives e.g., a flavorant such as a flavor concentrate, tea or coffee, and/or a vitamin supplement, an energy supplement, a water purification substance, and/or combinations thereof. Optionally, the flavorant may be in liquid and/or powder form.

Some embodiments of the current invention may include a liquid storage unit 112 ranging from 0.001 to 0.1 liters and/or between 0.1 liter to 0.25 liter and/or between 0.25 liter to 1 liter 1 liter and/or between 1 liter until 3 liters and/or 3 liters until 10 liters and/or 10 liters until 60 liters and/or 60 liters until 200 liters.

In some embodiments of the current invention, the liquid storage unit 112 may be made of various materials. For example, it may be made of plastic, ceramic, glass, silicon, metal, and/or stainless steel and/or other organic and/or inorganic materials, and/or combinations thereof. Alternatively, and/or additionally, the liquid storage unit 112 may be heat resistant. Optionally, the liquid container may have a steam hole 110. Optionally, the steam hole 110 may be near the top of liquid container 112. Optionally, the outer hole may be covered by a steam switch 108. For example, steam switch 108 may be located on the outside of the liquid container 112. Optionally, the steam switch 108 may comprise a switch extension 106. Optionally, the liquid container 112 may comprise a sealing ring, which may be flexible, semi-flexible or inflexible. Optionally, the sealing ring may be attached to a cover 104. Optionally, the cover 104 may be flexible, semi-flexible or inflexible. Optionally, the cover 104 may cover the hole on the inner surface of the liquid container 112. Optionally, the cover 104 may be made of various materials. For example, it may be made of plastic, and/or silicon, and/or metal, and/or stainless steel and/or other organic and/or inorganic materials and/or combinations thereof. Alternatively or additionally, the steam cover may be opened and/or closed by a servo connected to the power supply of the heating element and/or a sensor (for example of heat and/or pressure). Alternatively or additionally, there may be a pressure release (for example a valve to release pressure when internal pressure is greater than atmospheric pressure and/or a valve to allow pressure equalization when the pressure outside is higher than the internal pressure (e.g., when steam cools and/or produces a vacuum in the container 112)). For example, the pressure release may include a one way valve and/or a pressure relief valve and/or a regulator.

In an embodiment, the liquid heating system may have one or more optional heating modes. For example, on low power the system may keep liquid warm and/or slowly heat liquid. For example, on a higher power setting the heater may bring a liquid to a quick boil and/or keep the liquid at boiling temperature. Alternatively, and/or additionally, the heating system and/or multiple systems included in the invention may be fitted with a cover 102. For example, the cover 102 may be ventilated.

In an embodiment of the current invention, the liquid heating system may comprise one or more additional features, e.g., a pouring spout, a handle, a weight, a volume indicator, a carrying strap, etc. Optionally, the handle may be balanced to make it easy to manage, preferably, even for small and/or weak hands. Optionally, the liquid heating system may be used in areas where there is little to no infrastructure. e.g., for bathing, cooking and/or drinking. Optionally, the liquid heating system may be portable. For example, the liquid heating system may be easily carried for outdoor and/or indoor use, e.g., for use when camping, hiking, on public transport, during a lecture, etc. or any place where access to a conventional kettle is limited.

In an embodiment of the current invention the liquid heating system may include a singular and/or multiple control panels. For example, the control panel may be in the form of a touch screen alternatively and/or additionally it may be in the form of a physical control buttons. Alternatively, and/or additionally, an embodiment of the current invention may include an information panel and/or display. For example, a LED display. For example, the information panel may provide the user with information on the temperature status and/or battery the status and/or energy input status from a power source. Alternatively, and/or additionally, the control panel and the information panel may be on the same panel and/or touch screen. Alternatively, an external device may be used for controlling the liquid heating system. For example, the liquid heating system may be connected via a hard wired and/or wireless connection over radio, cellular and/or satellite network and/or controlled therefrom e.g., Bluetooth or cellular network connection to a cell phone, laptop computer, desk top computer, tablet, etc. Alternatively, and/or additionally, an embodiment of the current invention may include a singular and/or multiple active beating units.

In some embodiments, the panel may include one or more safety features. Optionally, the panel may include one or more indicators. Optionally, an indicator may show that the heating element is functioning. Optionally, an indicator may show that the liquid is hot. Optionally, the heat indicator could include gradations of heat. For example, a LED may change colors according to the temperature of the contents. For example, the LED may turn blue until about 40 degrees C. (e.g., at a temperature ranging between 35 to 45 degrees C.) and/or green at a temperature ranging from 40 to 60 degrees C. and/or yellow between 60 to 75 degrees C. and/or orange between 75 to 90 degrees and or red at above 90 degrees C. Optionally, different colors may be used for different temperature ranges.

Alternatively, and/or additionally, in an embodiment, the liquid heating system may have one or more safety features. Optionally, a safety feature may prevent activation of the heating element when the cover 104 is open (e.g., if the cover is open the steam may not go through the steam hole 110 and the switch 108 may never be turned off). Optionally, a safety feature may prevent activation when the liquid heating system is not right side up, e.g., if the liquid storage unit is upside down and/or tilted at more than an angle ranging between 5 to 20 and/or 20 to 45 and/or between 45 and 90 degrees.

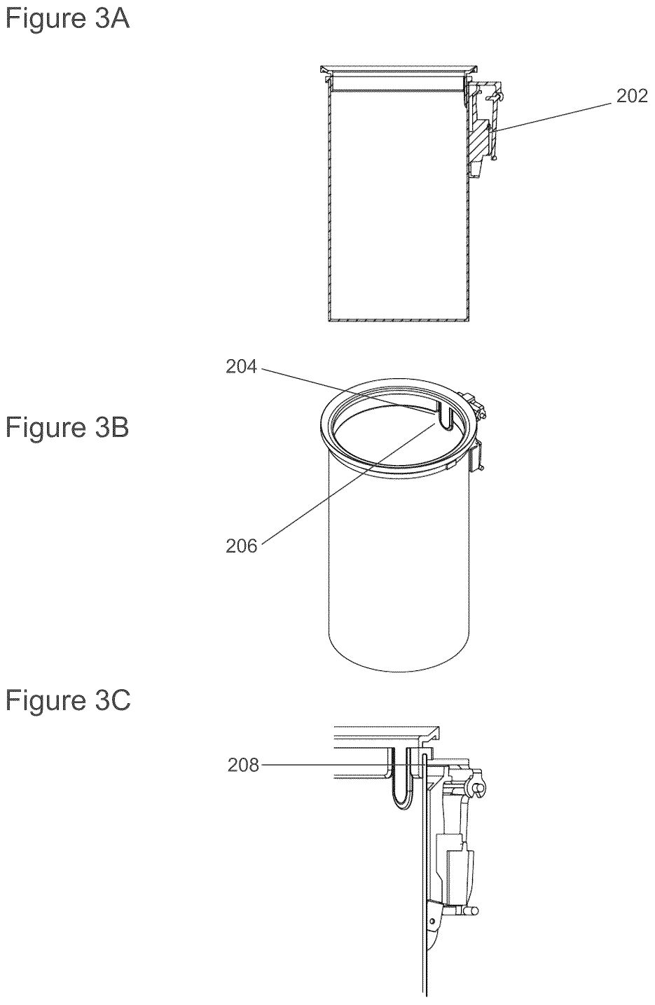

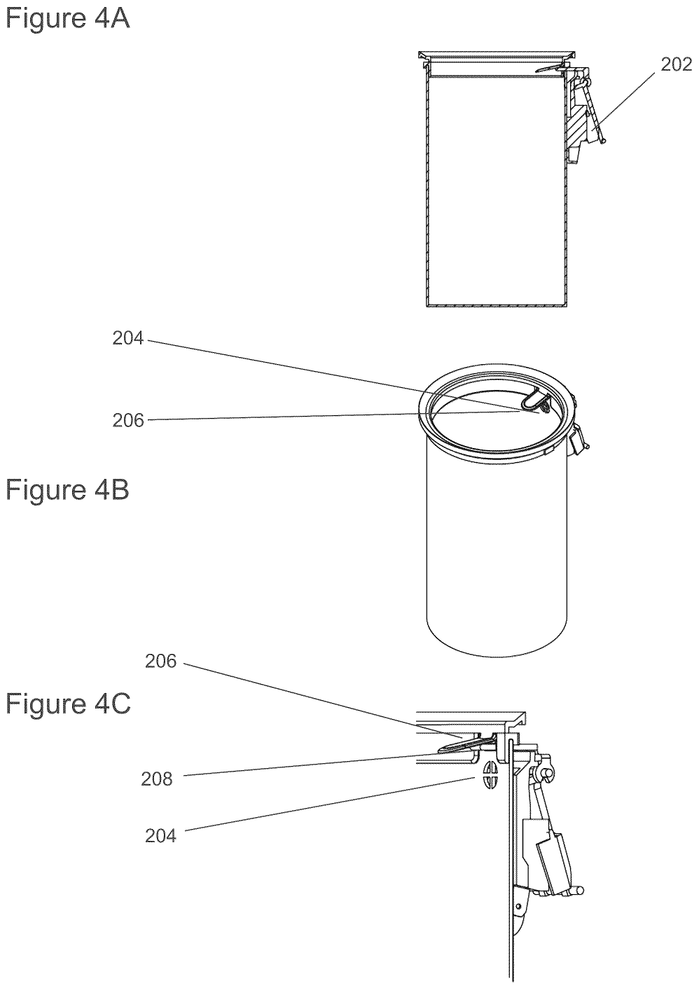

FIGS. 3A-3C illustrate an embodiment of the current invention in an inactive state. FIGS. 4A-4C illustrate an embodiment of the current invention in an active state.

In an embodiment of the invention the liquid heating system may include an activation and/or control switch 202. Optionally, switch 202 may be in an inactive (e.g., as illustrated in FIG. 3) or active state (e.g., as illustrated in FIG. 4). For example, when the switch 202 is turned on the heater may be activated. Additionally, and/or alternatively, in an embodiment, the steam outlet and/or steam hole 204 may be covered by a steam hole cover 206. Optionally, there may be a vacuum release such allowing air to enter the storage unit when a vacuum develops (e.g., when the steam cools). For example, the vacuum release may include a one-way valve in the storage unit 112, cover 102 and/or steam hole cover 206. Optionally, the steam hole cover may be opened and/or closed by the user. Optionally, when the liquid boils, steam is evolved and may pass through the open the steam hole 204 and/or heat may be released and/or may activate a sensor. Optionally, the steam release and/or sensor may trigger the release of the activation button and/or turn off the heating unit. Alternatively, and/or additionally, release of the activation and/or steam and/or heat may also trigger the closing of the steam opening. Optionally, this may improve the insulation when the heat is off. Optionally, the pushing of the activation switch may push a switch extension 208 and/or may push the steam hole cover 206 away from the steam hole thereby opening the steam hole 204 and/or when the switch is turned off the extension 208 may be released thus releasing the steam hole cover 206 thereby closing the steam hole 204. For example, when Switched ON, the extension 208 may move the cover to open the steam hole 204 and/or direct steam to the steam switch 202. As the steam builds up it may snap the switch back OFF automatically, Alternatively, and/or additionally, the switch 202 may be manually Switched OFF. When the switch is turned off, the steam cover 206 close the steam release hole and/or seal the container.

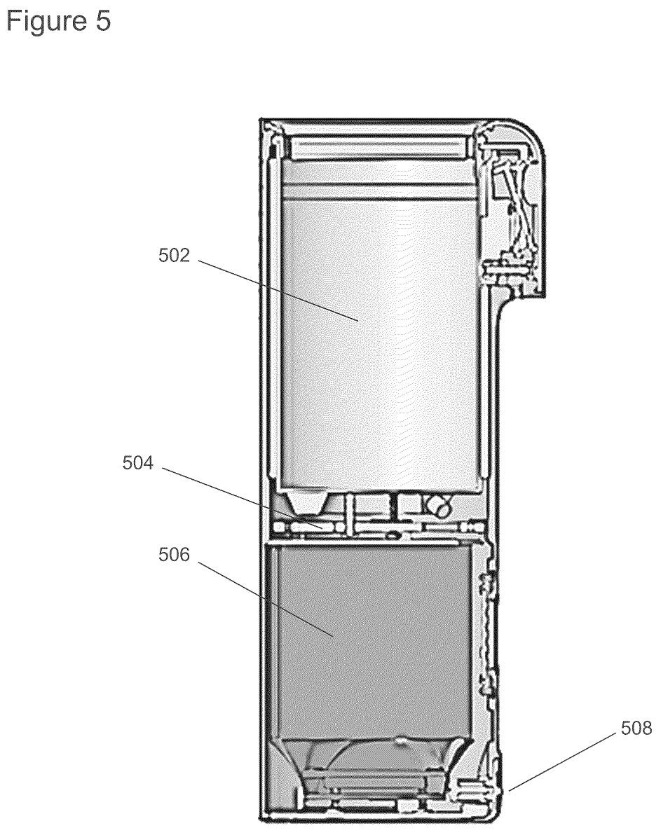

FIG. 5 is a schematic illustration in accordance with an embodiment of the current invention. In an embodiment of the current invention, the heating unit may be positioned in a way that the heating unit may not damage the insulation and/or liquid storage unit 502. For example, there may be material and/or space between the heating unit and/or an insulator that may prevent heat of the heating unit from reaching the insulation, for example via conductance. In some embodiments, a shield may inhibit radiant heating of vulnerable components (e.g., electronic components and/or the battery).

In some embodiments, the liquid heating system is surrounded by a casing. Optionally, the casing comprises a walled vessel. Optionally, the heating element and/or the power source may be insulated from the vessel walls. For example, this may prevent the vessel walls from conducting heat to the power source. Optionally, the power source and/or battery may be held by long and/or thin and/or low heat conductivity mounting struts. Optionally, the insulating material may include air, polystyrene foam, polyurethane foam, plastic, fiberglass, mineral wool, cellulose, cork, silicone, ceramic, and a radiant heat protector (e.g., a reflective layer), coating, etc. or combinations thereof.

Alternatively, and/or additionally, an embodiment of the current invention, the liquid heating system may include a power source 506. Optionally, the power source may include stored power (e.g., stored electrical for example, a singular and/or multiple rechargeable batteries. Optionally, the power source may be a connection to a wall socket, an external battery such as a car battery, car electronic lighter, photovoltaic cell, or any other AC or DC power source. Optionally, the power source may be used to charge the battery. Optionally, the power source may comprise a charging jack 508. For example, an embodiment of the current invention may include a rechargeable battery ranging from 100 to 1000 mAh and/or from 1000 to 10000 mAh and/or from 10000 to 100000 mAh. Optionally, the battery output may be about 24 V DC (e.g., ranging between 1 to 12 V and/or between 12 to 24 V and/or between 24 to 48 V). For example, the power supply may include a lithium battery and/or another kind of battery and/or a fuel cell and/or another power storage solution. Optionally, the power required may be much less than most standard kettles (which generally use 110/220 AC house current). Optionally, the current required may be high to provide the power required to heat the liquid in the liquid storage unit. Optionally, electrical wires connect between the electrical components. Optionally, the switch and/or the electrical wires may be designed for high current and/or low voltage. Optionally, the electrical wires may be designed to carry 50 volts of electricity or less. Optionally, the electrical wires may be designed to carry electricity in the range 1 to 12V and/or 12 to 24V and/or 24 to 48V. Optionally, the electrical wires may be 1 to 6-gauge and/or 6 to 10-gauge and/or 10 to 12-gauge and/or 12 to 16-gauge and/or 16 to 20-gauge wire

In some embodiment, the connections (e.g., electrical wires and/or supports) between the heating element and the power source may be configured to inhibit heat transfer between the battery and electronic components and/or the heating element and/or the fluid being heated. For example, wires and/or supports long and/or relatively thin and/or made of and/or surrounded by a reduced heat conducting material.

In some embodiments, the battery may store enough energy to boil at least 1.5 times the maximum liquid capacity of the liquid storage unit without recharging. For example, the battery may be about 24 V DC may need 25 Amp (e.g., 25 Amp×24 V=600 Watt) as compared to a standard electric kettle that uses 110/220 AC house current and needs only 3 Amp (e.g., 3 Amp×220 V=660 Watt).

Alternatively, and/or additionally, the battery and/or the power system of embodiment of the current invention may have a power jack 508. For example, a 2.5 DC Jack. Alternatively, or additionally, the heating system may include an adapter to receive power from a vehicle and/or to recharge the battery. For example, DC power at 12V from an external battery such as a car cigarette lighter and/or 12.8V from a car battery and/or 5V from a USB power source or the like. Alternatively, or additionally, the current invention may include a photovoltaic system.

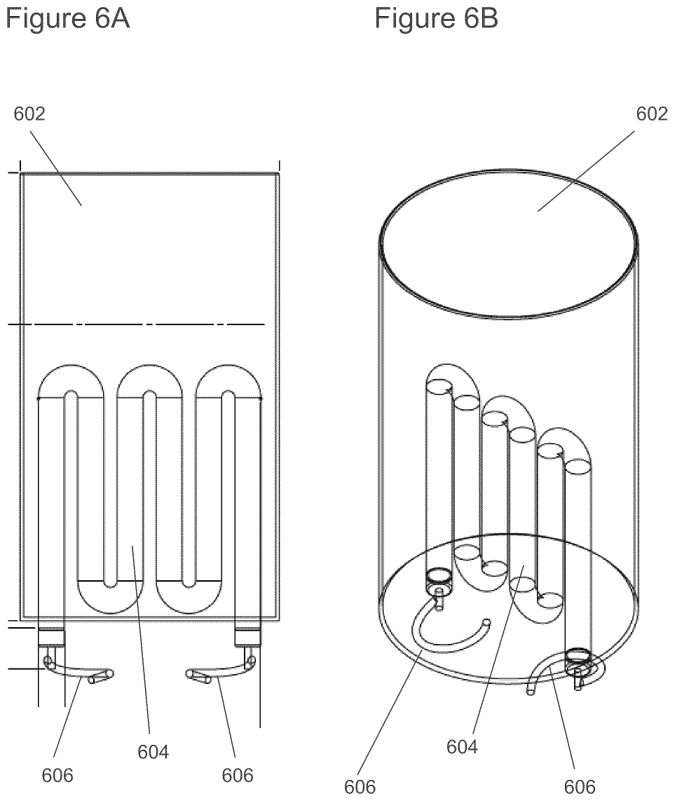

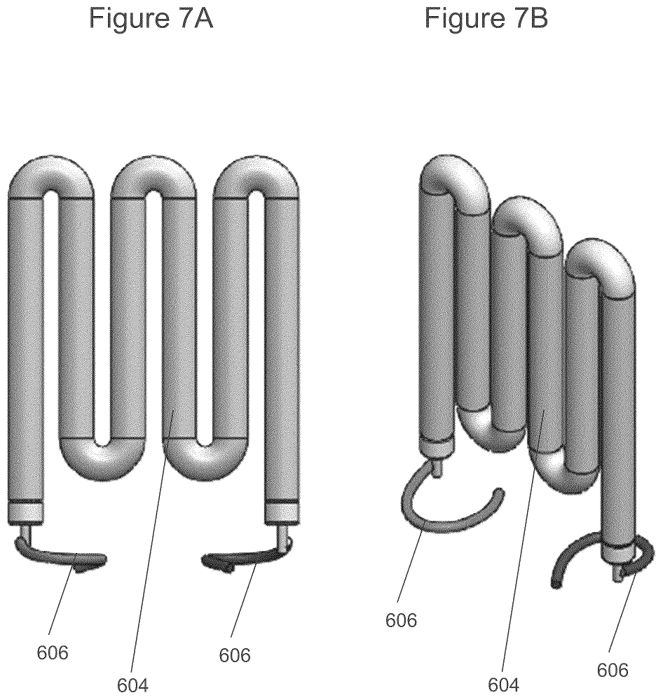

FIGS. 6A, 6B, 7A and 7B are schematic illustrations of a heating element in accordance with an embodiment of the current invention.

In an embodiment of the current invention, a heating element 604 may be located within the interior 602 of the liquid storage unit. Optionally, a spiral heating element may be used and/or another shape. In some embodiments, the heating element may be on the outside of vessel 602 and/or in contact with the outside wall of vessel 602.

In some embodiments, the heating element 604 may be connected by wires 606 to a power source. Optionally, the electrical wires 606 between the heating element 604 and the power source may be long and/or relatively thin and/or made of a reduced heat conductive material. For example, the electrical wires 606 may take a long and/or torturous path (e.g., a spiral path) around and/or through the heating element.

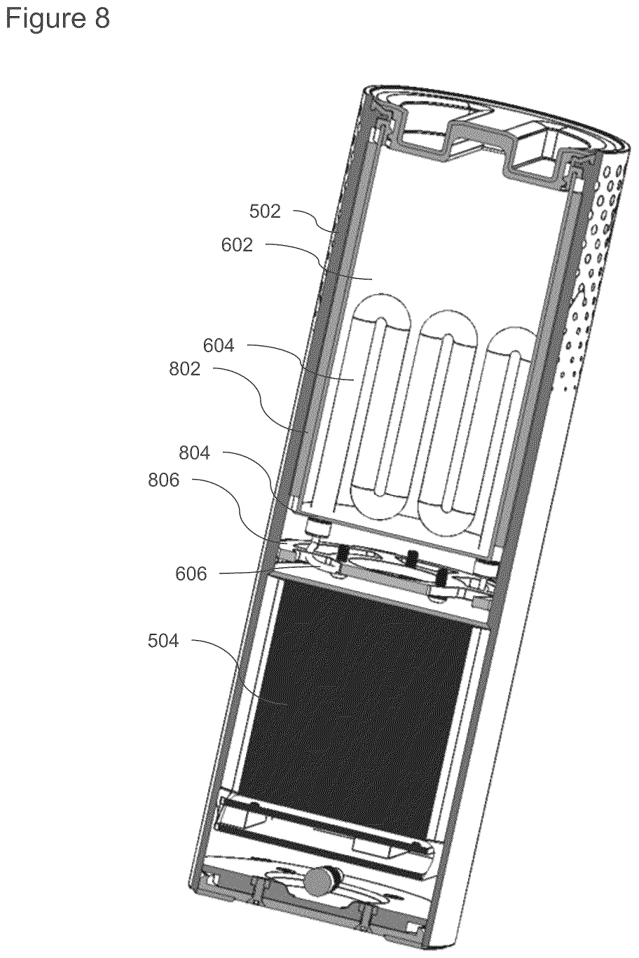

FIG. 8 is a schematic illustration of a liquid heating system in accordance with an embodiment of the current invention.

In an embodiment, the liquid heating system may comprise a vessel with vessel walls 802 and a vessel interior 602, e.g., a liquid storage unit. Optionally, the vessel interior 602 may comprise a heating element 604. Optionally, there may be space insulating between the heating element 604 and the internal wall 802 for heat insulation. Optionally, an insulated mounting plate 806 may sit between the battery 504 and the internal wall 802. Optionally, a long and/or twisted wire 606 may insulate between the heating element 604 and battery 504. Optionally, there may be insulation between the hot liquid and/or the heating element and one or more walls 802 of the liquid heating system. Optionally, a thin and/or insulated mounting plate 804 may separate between the heating element 604 and one or more walls 802 of the vessel.

Alternatively, and/or additionally, an embodiment of the current invention the liquid heating system may have an insulator and/or insulation shell. Alternatively, and/or additionally, the insulator may be of various materials. For example, it may include air, polystyrene foam, polyurethane foam, plastic, fiberglass, mineral wool, cellulose, cork, ceramic, coating, and/or a radiant heat protector and/or other organic and/or inorganic materials and/or a combination thereof. Alternatively, and/or additionally, the insulator may be of various thicknesses. For example, some embodiments of the current invention may include an insulator ranging from 0.001 mm thick until 3 mm thick and/or between 3 mm until 1 cm thick and/or 1 cm thick until 5 cm thick and/or 5 cm thick until 20 cm thick and/or 20 cm until 1 meter thick. Alternatively, and/or additionally, the insulator and/or insulator shell may cover the liquid storage unit all around and/or from multiple sides. For example, three of the adjacent sides.

An embodiment of the current invention may have an external shell and/or casing which may prevent heat conductance. For example, a plastic shell and/or a coating.

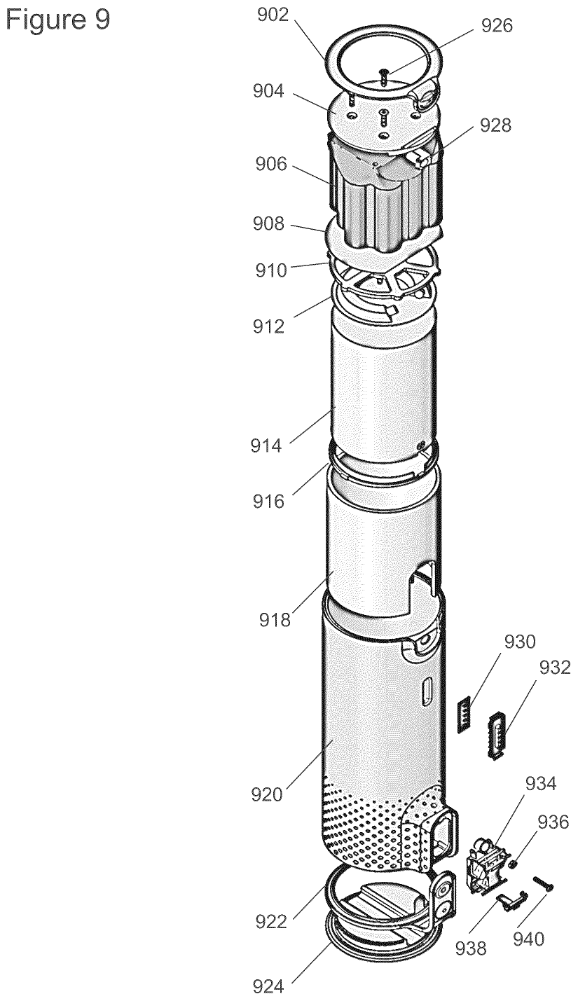

FIG. 9 is an exploded view of liquid heating system for storing and heating liquid in accordance with an embodiment of the current invention.

Optionally, the liquid heating system may comprise one or more of the following components:
902 Silicone—DC jack+bottom protection
904 Plastic—bottom cover
906 Battery pack (including BTS)
908 Plastic—Battery stopper
910 Al/fiberglass nylon—cup bracket
912 Heating element
914 Stainless steel—cup
916 Plastic—Cup thread
918 Polyurethane Foam—insulation
920 Plastic—shell
922 Silicone—sealing ring+switch cover
924 Plastic—lid+silicone over-mold
926 M3×14 flat screw*4
928 Charging DC Jack
930 LED PCB
932 Plastic—LED display
934 Steam switch
936 M3 nut
938 M3×14 pan screw
940 Steam release pin

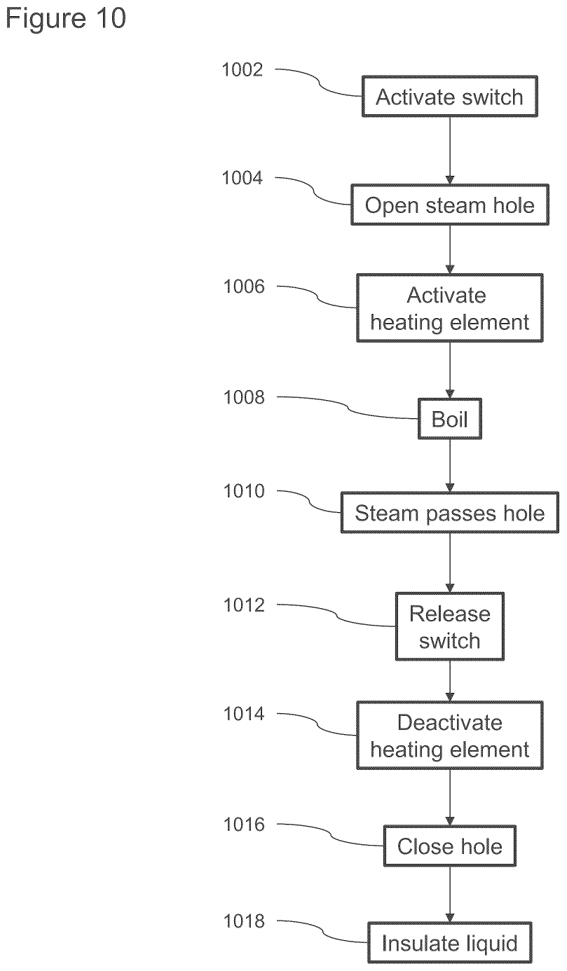

FIG. 10 is a flow chart illustration of a method of heating and/or boiling a liquid in accordance with an embodiment of the current invention.

For example, a user may fill the liquid heating system with a liquid and/or store the liquid therein until heating is required. The user may then activate the switch 1002, and open the steam hole 1004, then activate the heating element 1006 which may bring the liquid to a boil 1008. The steam evolved may then pass through the steam hole 1010, which may release the switch 1012, deactivating the heating element 1014. The steam hole may then be closed 1016 to further insulate the liquid 1018. Optionally, the method may include charging a battery and/or the heating may be by means of energy stored in the battery.

In some embodiments, storing, insulating, and/or heating may be combined. For example, a user may fill the liquid heating system with hot liquid. Optionally, while the liquid is stored and/or transported in the liquid heating system insulation may keep the liquid warm. Optionally, at a later time, when the user desires the liquid to be very hot and/or boiling, the heater of the liquid heating system may be used to reheat the liquid to a higher temperature and/or to reboil the liquid.

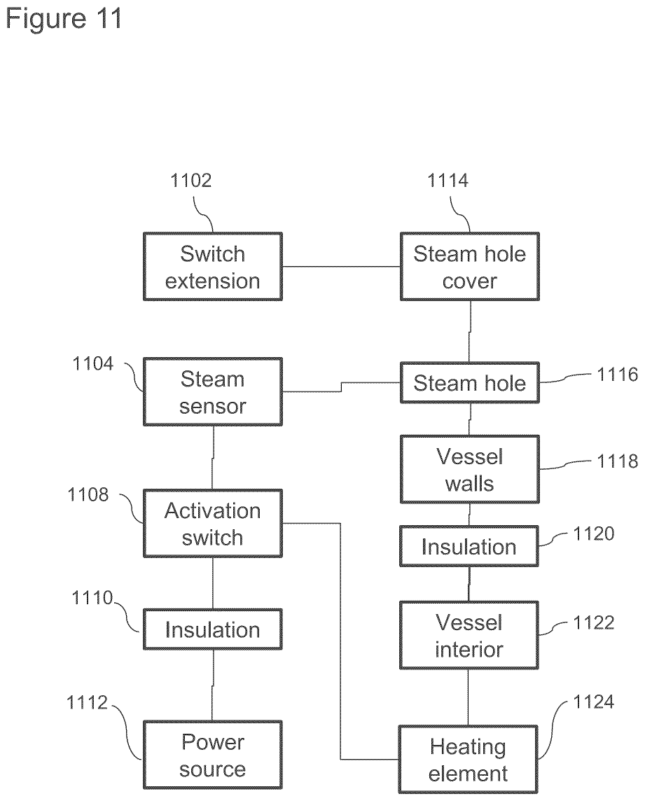

FIG. 11 is a block diagram of a liquid heating system in accordance with an embodiment of the current invention. In an embodiment, the liquid heating system may comprise one or more of the following components: a switch extension 1102 which may be connected to a steam hole cover 1114, which may reversibly cover a steam hole 1116 in the vessel walls 1118. The steam hole 1116 may be connected to a steam sensor 1104 which in turn may be connected to an activation switch 1108, which may be insulated 1110 from a power source. Additionally, the vessel walls 1118 may be insulted 1120 from the vessel interior 1122. In some embodiments, heating element 1124 may be located in the vessel interior 1122. Alternatively or additionally, the heating element 1124 may be on the outside of vessel walls 1118 and/or in contact with the vessel wall 1118, which may be activated by the activation switch 1108. A power source 1112 optionally supplies power to the heading element 1124 via the activation switch 1108. In some embodiments, a spiral heating element 1124 may be used and/or another shape.

In an embodiment, all or part of the liquid heating system may be made from recycled and/or recyclable materials.

In an embodiment, all or part of the liquid heating system may be recyclable and/or reusable.

### General

It is expected that during the life of a patent maturing from this application many relevant building technologies, artificial intelligence methodologies, computer user interfaces, image capture devices will be developed and the scope of the terms for design elements, analysis routines, user devices is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A liquid heating system comprising:
a liquid storage unit comprising a container with a steam hole configured for allowing steam generated by beating the liquid in the liquid storage unit to escape therethrough;
a steam hole cover, which covers the steam hole;
a heating element, located within the liquid storage unit to heat the liquid in the liquid storage unit;
an activation switch, connected to the steam hole cover and to the heating element such when the activation switched is in an on position, the heating element is activated and the steam hole is opened and when the activation switched is in an off position, the heating element is deactivated and the steam hole is closed; and
a power source, for supplying power connected to the activation switch and to the heating element.

2. The liquid heating system of claim 1, further comprising a cover to the liquid storage unit.

3. The liquid heating system of claim 1, further comprising a casing surrounding the liquid heating system.

4. The liquid heating system of claim 1, further comprising: electrical wires connecting the power source to the activation switch and to the heating element are made from or are surrounded by a reduced heat conducting material.

5. The liquid heating system of claim 1, wherein the power source contains stored power.

6. The liquid heating system of claim 5, wherein the power source is selected from a rechargeable battery and an external battery.

7. The liquid heating system of claim 1, wherein the power source is selected from a photovoltaic system, a wall socket, an AC power source, or a DC power source.

8. The liquid heating system of claim 1, wherein at least one of the liquid storage unit, the power source, and connecting electrical wires are insulated by a heat insulator.

9. The liquid heating system of claim 8, wherein the heat insulator includes a reduced heat conducting material.

10. The liquid heating system of claim 9, wherein the reduced heat conducting material is selected from at least one of air, polystyrene foam, polyurethane foam, silicone, plastic, fiberglass, mineral wool, cellulose, cork, ceramic, a radiant heat protector, a coating.

11. The liquid heating system of claim 1, wherein closing the steam hole with the steam hole cover assists in insulating the liquid storage unit.

12. The liquid heating system of claim 1, further comprising a control panel.

13. The liquid heating system of claim 12, wherein the control panel is connected to the activation switch and to the power supply.

14. The liquid heating system of claim 12, wherein the control panel includes one or more indicators.

15. The liquid heating system of claim 14, wherein an indicator shows that the heating element is functioning.

16. The liquid heating system of claim 14, wherein an indicator shows that the liquid is hot.

17. The liquid heating system of claim 1, further comprising a safety feature.

18. The liquid heating system of claim 1, wherein the liquid heating system is portable.

19. The liquid heating system of claim 2, wherein the liquid storage unit cover is opened to add at least one of a liquid and an additive wherein the additive is selected from a flavorant, a vitamin supplement, an energy supplement, a water purification substance.

20. A method for storing and heating liquid comprising:
storing a liquid in a liquid storage unit until heating is required;
activating a switch;
opening a steam hole in the liquid storage unit in response to said activating;
drawing power from a power source to a heating element contained within the liquid storage unit in response to said activating to produce heat;
heating the liquid in the liquid storage unit with said heat to boil said liquid;
passing steam from the boiled liquid through the steam hole;
releasing the switch in response to said passing; and
deactivating of the heating element in response to said releasing.

21. The method of claim 20, wherein activating the switch results in pushing a switch extension thereby moving a steam hole cover away from the steam hole and opening the steam hole.

22. The method of claim 20, wherein deactivating the switch results in releasing a switch extension allowing a steam hole cover to close the steam hole.

23. The method of claim 20, further comprising preventing activating the heating element when the liquid storage unit is open.

24. The method of claim 20, further comprising preventing activating the heating element when the liquid storage unit is not right side up.

25. The method of claim 20, further comprising insulating the liquid storage unit by closing a cover of the steam hole in response to said deactivating of the heating element.

26. The method of claim 20, further comprising storing the heated liquid for later use.

27. The method of claim 20, further comprising reheating stored liquid.

28. The method of claim 20, further comprising controlling the heating via a hard wired or wireless connection.
